(19) United States
(12) Patent Application Publication
(10) Pub. No.: US 2009/0051797 A1
(43) Pub. Date: Feb. 26, 2009

(54) DIGITAL IMAGE CAPTURING DEVICE AND METHOD FOR CORRECTTING IMAGE TILT ERRORS

(75) Inventor: HSUAN YAO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/937,399

(22) Filed: Nov. 8, 2007

(30) Foreign Application Priority Data
Aug. 24, 2007 (CN) 200710201456.4

(51) Int. Cl. H04N 5/335

(52) U.S. Cl. 348/308

(57) ABSTRACT

An digital image capturing device includes an image sensor, a tilt sensor, an image processor, and a memory device. The image sensor is configured for capturing an image of an object. The tilt sensor is configured for sensing a tilt angle of the image sensor. The image processor is configured for adjusting an orientation of the captured image based on the sensed tilt angle to correspond to the orientation of the object. The memory device is used for storing the adjusted image.

### TECHNICAL FIELD

The present invention relates to digital image processing to eliminate errors introduced during the image capturing phase and, more particularly, to a digital image capturing device and a method for correcting tilt or orientation errors introduced during image capture.

### DESCRIPTION OF RELATED ART

With the development of electro-optical imaging technology, digital image capturing devices are widely used in electronic devices, such as digital cameras and mobile phones.

The image capturing devices are usually held by a user or supported by a tripod when being used for capturing an image. So, when the user's hand shakes or if the tripod is not level during image capturing, the image captured will be tilted and not comfortable for viewing.

What is needed, therefore, is a digital image capturing device which can eliminate errors caused by the image capturing device being tilted during the image capturing phase.

### SUMMARY

In accordance with one present embodiment, a digital image capturing device includes an image sensor, a tilt sensor, an image processor, and a memory device. The image sensor is configured for capturing an image of an object. The tilt sensor is configured for sensing a tilt angle of the image sensor. The image processor is configured for adjusting an orientation of the captured image based on the sensed tilt angle to correspond to the orientation of the object. The memory device is used for storing the adjusted image.

### BRIEF DESCRIPTION OF THE DRAWING

Many aspects of the present digital image capturing device can be better understood with reference to the following drawings. The components in the drawing are not necessarily drawn to scale, the emphasis instead being placed upon clearly illustrating the principles of the present digital image capturing device. Moreover, in the drawings, like reference numerals designate corresponding parts throughout the several views.

FIG. 1 is a schematic, functional block diagram of a digital image capturing device according to a present embodiment;

FIG. 2 is an image captured by the digital image capturing device of FIG. 1 when the image capturing device is tilted;

FIG. 3 is the image of FIG. 2 rotated;

FIG. 4 is the image of FIG. 3 cropped; and

FIG. 5 is a flow chart of a method for correcting image tilt errors of the image capturing device of FIG. 1.

### DETAILED DESCRIPTION OF THE EMBODIMENTS

Embodiments will now be described in detail below, with reference to the drawings.

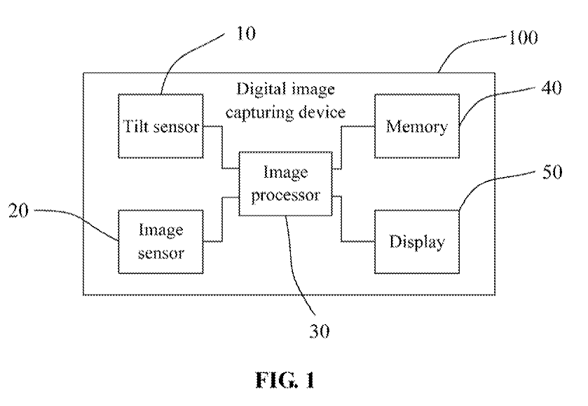

Referring to FIG. 1, a digital image capturing device 100, according to an embodiment, is shown. The device 100 includes a tilt sensor 10, an image sensor 20, an image processor 30, a memory device 40, and a display 50, which are each electrically connected to and able to interface with the image processor 30. The device 100 can be a digital camera, a video camera, or a mobile phone having a digital image capturing function.

The tilt sensor 10 is used for sensing a tilt angle of the image sensor 20 during the image capturing phase of the device 100. The tilt angle is usually equal to the angle between the center axis of the device 100 and horizontal. The tilt angle is also usually equal to the angle between horizontal and the bottom surface of the device 100.

The image sensor 20 is configured for capturing an image of an object and outputting a signal to the image processor 30. The image sensor 20 can be a charge-coupled device (CCD) or a complementary metal oxide semiconductor device (CMOS). The image sensor 20 can further be selected from a group consisting of a ceramic leaded chip carrier (CLCC) package type image sensor, a plastic leaded chip carrier (PLCC) package type image sensor, and a chip scale package (CSP) type image sensor.

The image processor 30 can receive information from the tilt sensor 10 and the output signal from the image sensor 20. The information represents a tilt angle of the image sensor 20 during image capturing phase of the device 100. The image processor 30 can adjust the captured image according to the information received from the tilt sensor 10 by rotating the image to compensate for the sensed angle of tilt.

The memory device 40 is used for storing the corrected image. The memory device 40 can be either permanent on board memory within the camera, removable memory, or a combination of both. Example components suitable for memory device 40 include SDRAM, non-removable flash memory, removable flash-card, compact flash memory card, memory stick, and SmartMedia.

The display 50 is used for viewing images inside the device 100. The display 50 can also be used as a viewfinder.

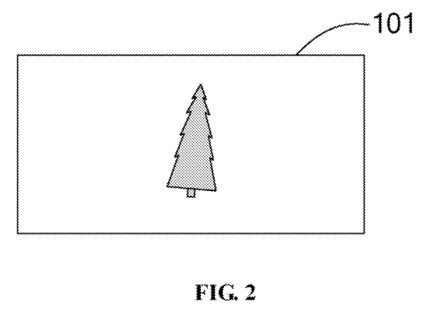

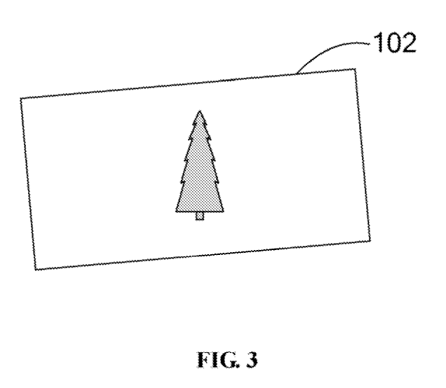

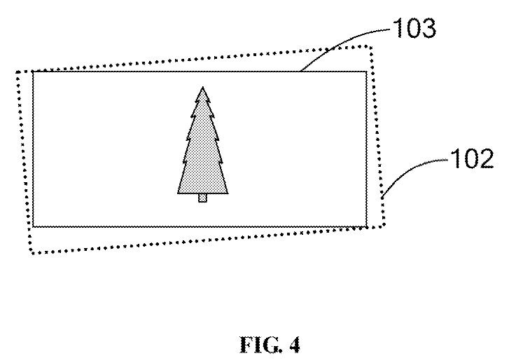

Referring to FIG. 2 to FIG. 4, an example of correcting a tilted image captured by the device 100 is shown. The first picture 101 shows a tilted image captured by the device 100. The second picture 102 shows the image rotated to compensate for the tilt. Then, to compensate for the now tilted borders of the image, a third picture 103 is obtained by cropping the borders resulting in a desired orientation of both image and borders of the image.

Sensitivity of the present and other embodiments to the degree of angle of tilt during the image capturing phase may be pre-set as desired to avoid unnecessary compensation for very acute angles of tilt and/or for great angles of tilt purposefully done by a user for effect.

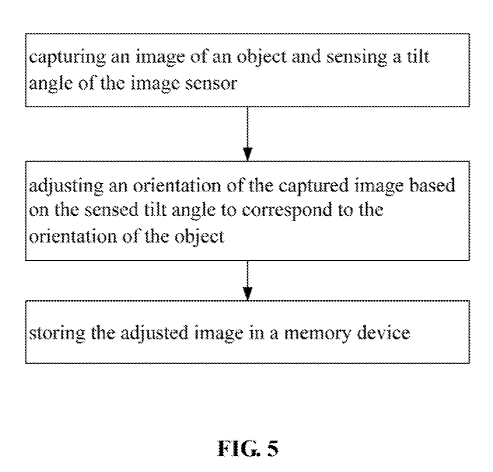

Referring to FIG. 5, a method for correcting image tilt errors is also provided. The method includes the steps of: capturing an image of an object and sensing a tilt angle of the image sensor 20 during the image capturing phase of the image capturing device 100; adjusting an orientation of the captured image based on the sensed tilt angle to correspond to the orientation of the object; and storing the adjusted image in a memory device 40.

The method can further include a step of comparing the sensed tilt angle to a preset minimal angle before correcting tilt errors of the captured image. If the sensed tilt angle is equal to or greater than the preset minimal angle, than performs the step of adjusting an orientation of the captured image. If the sensed tilt angle is equal to or smaller than the preset minimal angle, the image will not be adjusted. The method can further include a step of comparing the sensed tilt angle to a preset maximal angle before correcting tilt errors of the captured image. If the sensed tilt angle is equal to or greater than the preset maximal angle, the image will not be adjusted.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. An image capturing device comprising:
an image sensor configured for capturing an image of an object;
a tilt sensor for sensing a tilt angle of the image sensor;
an image processor for adjusting an orientation of the captured image based on the sensed tilt angle to correspond to the orientation of the object; and
a memory device for storing the adjusted image.

2. The image capturing device as claimed in claim 1, wherein the image capturing device is selected from a group consisting of a digital camera, a video camera, and a mobile phone.

3. The image capturing device as claimed in claim 1, wherein the image sensor is selected from one of a charge-coupled device and a complementary metal oxide semiconductor device.

4. The image capturing device as claimed in claim 1, wherein the image sensor is selected from a group consisting of a ceramic leaded chip carrier package type image sensor, a plastic leaded chip carrier package type image sensor, and a chip scale package type image sensor.

5. The image capturing device as claimed in claim 1, wherein the image processor is configured for adjusting an orientation of the captured image if the tilt angle is equal to or greater than a preset minimal angle.

6. The image capturing device as claimed in claim 1, wherein the image processor is configured for adjusting an orientation of the captured image if the tilt angle is equal to or less than a preset maximal angle.

7. The image capturing device as claimed in claim 1, wherein the tilt angle is the angle between a lowermost edge of the image sensor and the horizontal level.

8. A method for correcting image tilt errors comprising the steps of:
capturing an image of an object;
sensing a tilt angle of the image sensor;
adjusting an orientation of the captured image based on the sensed tilt angle to correspond to the orientation of the object; and
storing the adjusted image in a memory device.

9. The method as claimed in claim 8, further comprising a step of comparing the sensed tilt angle to a preset minimal angle, and adjusting the orientation of the captured image if the sensed tilt angle is equal to or greater than the preset minimal angle.

10. The method as claimed in claim 8, further comprising a step of comparing the sensed tilt angle to a preset maximal angle, and adjusting the orientation of the captured image if the sensed tilt angle is equal to or less than the preset maximal angle.
